(19) United States
(12) Patent Application Publication
(10) Pub. No.: US 2023/0272670 A1
(43) Pub. Date: Aug. 31, 2023

(54) STEPLADDER WITH PLATFORM SPREADER

(71) Applicant: Tricam Industries, Inc., Eden Prairie, MN (US)

(72) Inventors: Joseph P. Foley, St. Paul, MN (US); Benjamin P. WIlliams, Chaska, MN (US)

(21) Appl. No.: 18/311,939

(22) Filed: May 4, 2023

Related U.S. Application Data
(63) Continuation-in-part of application No. 29/822,958, filed on Jan. 13, 2022.

(51) Int. Cl. E06C 1/393; E06C 1/20; E06C 7/16; E06C 7/00

(52) U.S. Cl. CPC E06C 1/393; E06C 1/20; E06C 7/16; E06C 7/00

(57) ABSTRACT

A stepladder including a pair of front rails, a pair of second rails, a top cap, a fixed step, and a spreader mechanism. The spreader mechanism includes a platform pivotably mounted to the pair of front rails, spreader arms pivotably mounted to the pair of rear rails , and spreader pivot. The stepladder is moveable between a closed position and an open position, the open position limited by the spreader mechanism.

### CROSS-REFERENCE TO RELATED APPLICATIONS

This application is a continuation of application Ser. No. 29/822,958, filed Jan. 13, 2022, which is hereby fully incorporated herein by reference.

### FIELD OF THE INVENTION

The invention relates generally to ladders, and more specifically to a stepladder having a foldable platform step forming part of the stepladder spreader mechanism.

### BACKGROUND OF THE INVENTION

Stepladders have historically been manufactured with fixed steps. Improvements to stepladders included providing a platform as the top step of the stepladder to provide additional room, user comfort, and safety.

### SUMMARY OF THE INVENTION

In one embodiment, a ladder comprising a first frame, a second frame, a fixed step coupled to the first frame, and a platform assembly. The platform assembly includes a first platform pivotably coupled to the first frame, a second platform pivotably coupled to the first frame, a first linkage coupled between the second frame and one of the first platform and the second platform, and a second linkage coupled to the first platform and the second platform, wherein the ladder is configured to be movable between a closed position and an open position.

In one embodiment, a ladder comprising a first frame having a thickness, a second frame, and a platform assembly including a first platform pivotably coupled to the first frame and a second platform pivotably coupled to the first frame, wherein the ladder is configured to be movable between an open position and a closed position and wherein the platform assembly is configured to be positioned at least partly within a boundary defined by the thickness when the ladder is in the closed position

### BRIEF DESCRIPTION OF THE DRAWINGS

Embodiments of the present invention may be more completely understood in consideration of the following detailed description of various embodiments of the invention in connection with the accompanying drawings, in which:

FIG. 1 is a perspective front profile view of a stepladder in an open, in-use position according to an embodiment of the invention.

FIG. 2 is a front elevation view of the stepladder of FIG. 1.

FIG. 3 is a rear elevation view of the stepladder of FIG. 1.

FIG. 4 is a left side elevation view of the stepladder of FIG. 1.

FIG. 5 is a right side elevation view of the stepladder of FIG. 1.

FIG. 6 is a top plan view of the stepladder of FIG. 1.

FIG. 7 is a bottom plan view of the stepladder of FIG. 1.

FIG. 8 is a perspective front profile view of the stepladder of FIG. 1 in a closed, stored position.

FIG. 9 is a front elevation view of the stepladder of FIG. 8.

FIG. 10 is a rear elevation view of the stepladder of FIG. 8.

FIG. 11 is a left side elevation view of the stepladder of FIG. 8.

FIG. 12 is a right side elevation view of the stepladder of FIG. 8.

FIG. 13 is a bottom plan view of the stepladder of FIG. 8.

FIG. 14 is a top plan view of the stepladder of FIG. 8.

FIG. 15 is a perspective front profile view of the stepladder of FIG. 1 in an intermediate position.

FIG. 16 is a front elevation view of the stepladder of FIG. 15.

FIG. 17 is a rear elevation view of the stepladder of FIG. 15.

FIG. 18 is a left side elevation view of the stepladder of FIG. 15.

FIG. 19 is a right side elevation view of the stepladder of FIG. 15.

FIG. 20 is a top plan view of the stepladder of FIG. 15.

FIG. 21 is a bottom plan view of the stepladder of FIG. 15.

While the various embodiments of the invention are amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the inventions as may be claimed.

### DETAILED DESCRIPTION OF THE INVENTION

The following detailed description should be read with reference to the drawings in which similar elements in different drawings are numbered the same. The drawings, which are not necessarily to scale, depict illustrative embodiments and are not intended to limit the scope of the inventions as claimed.

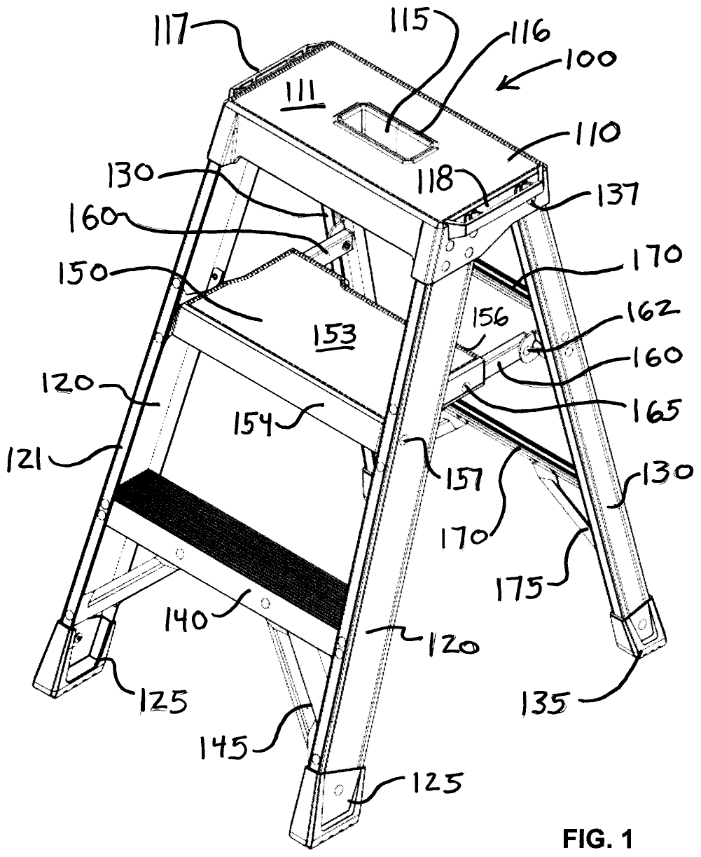

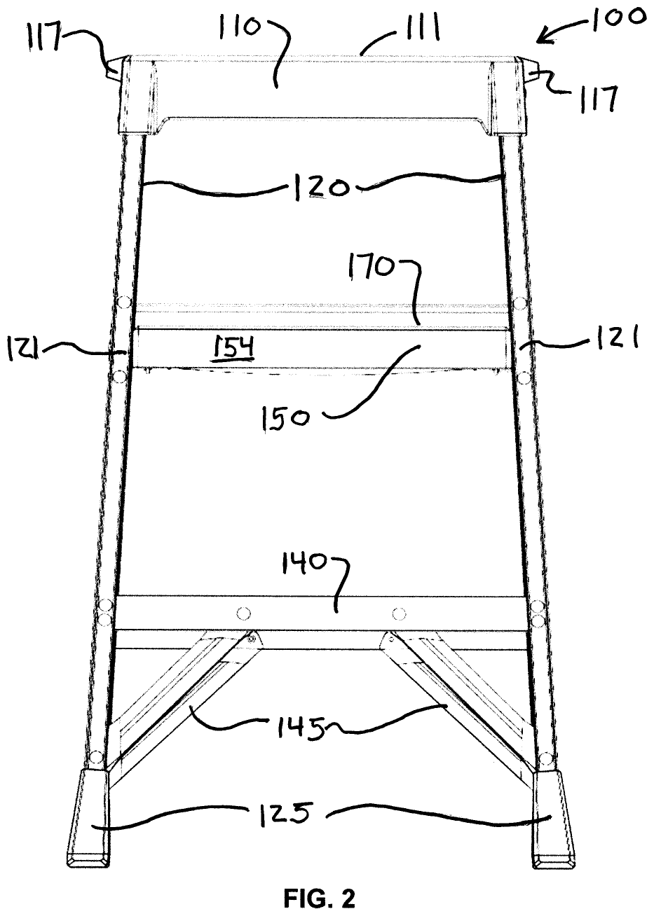

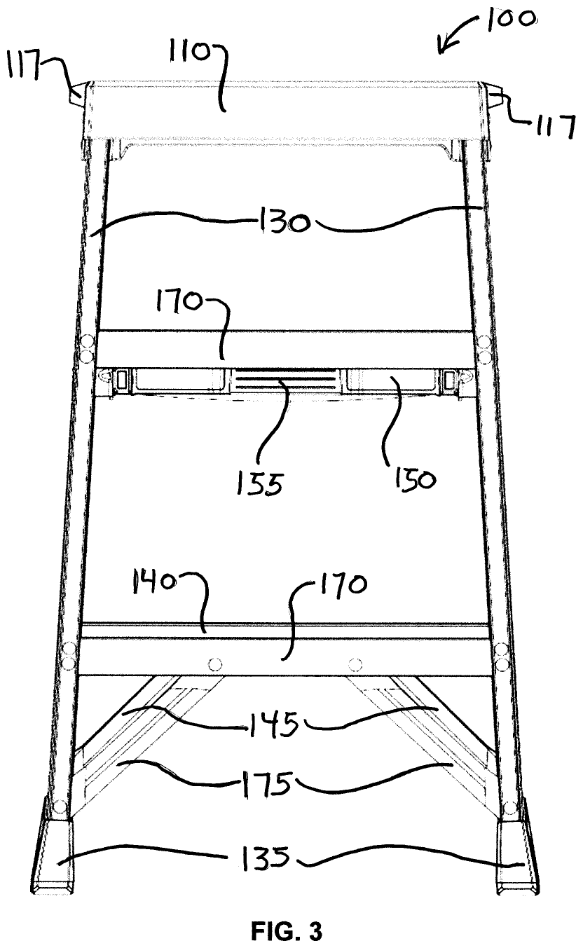

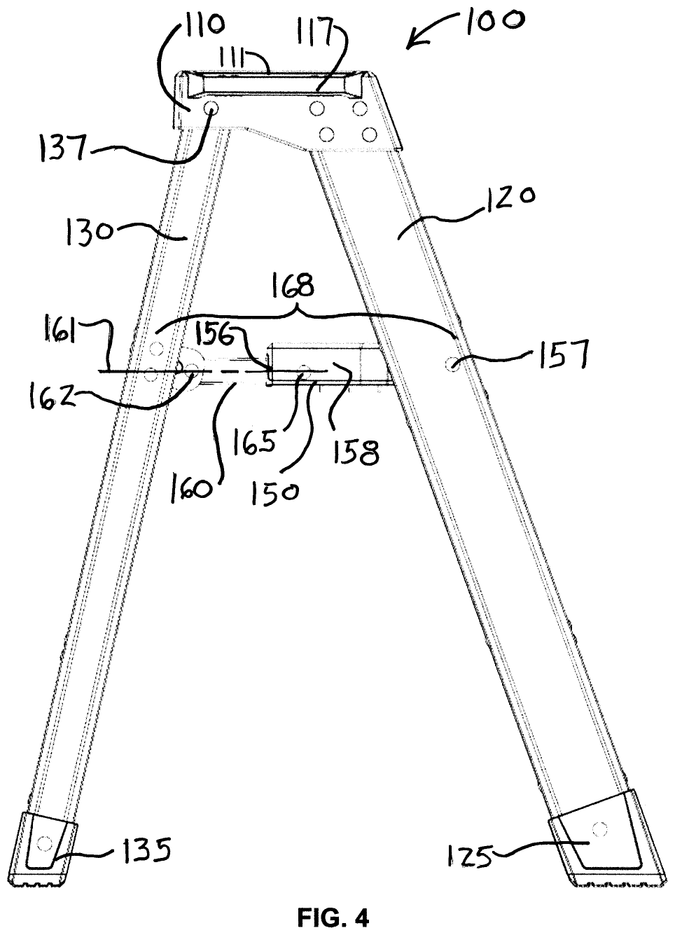

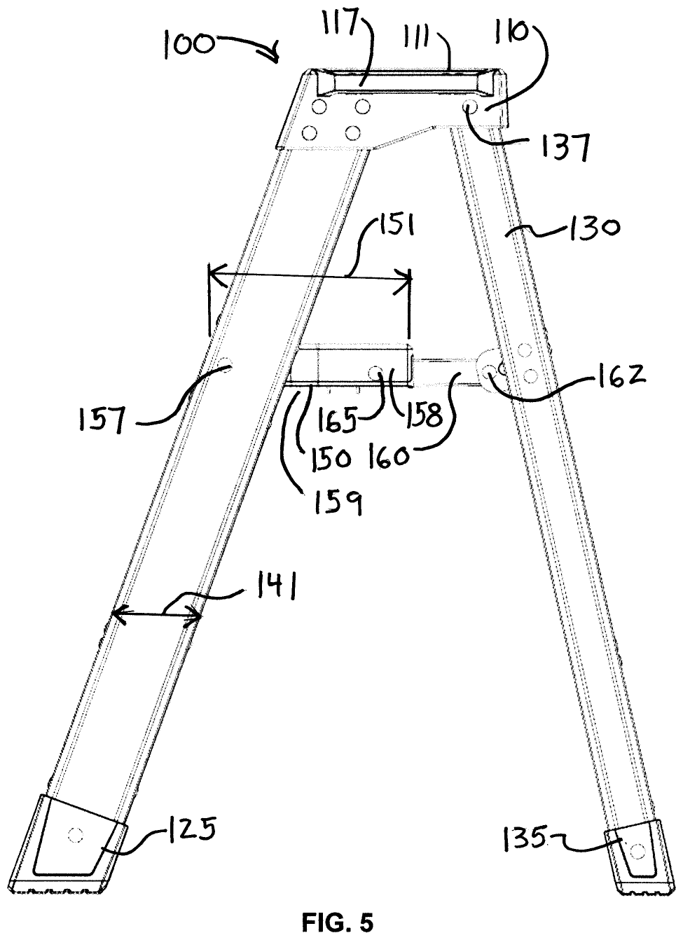

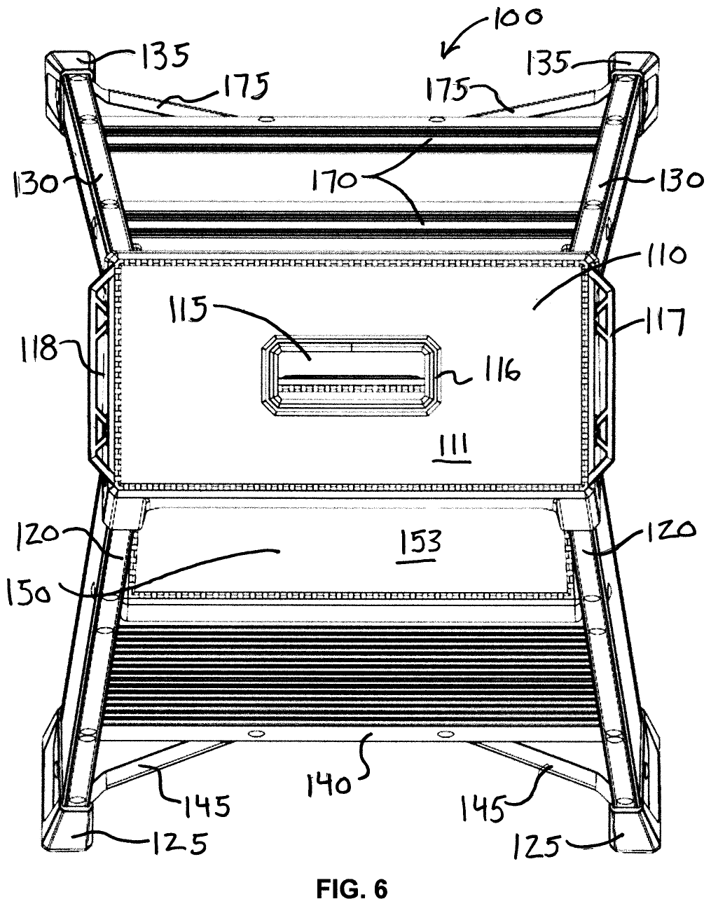

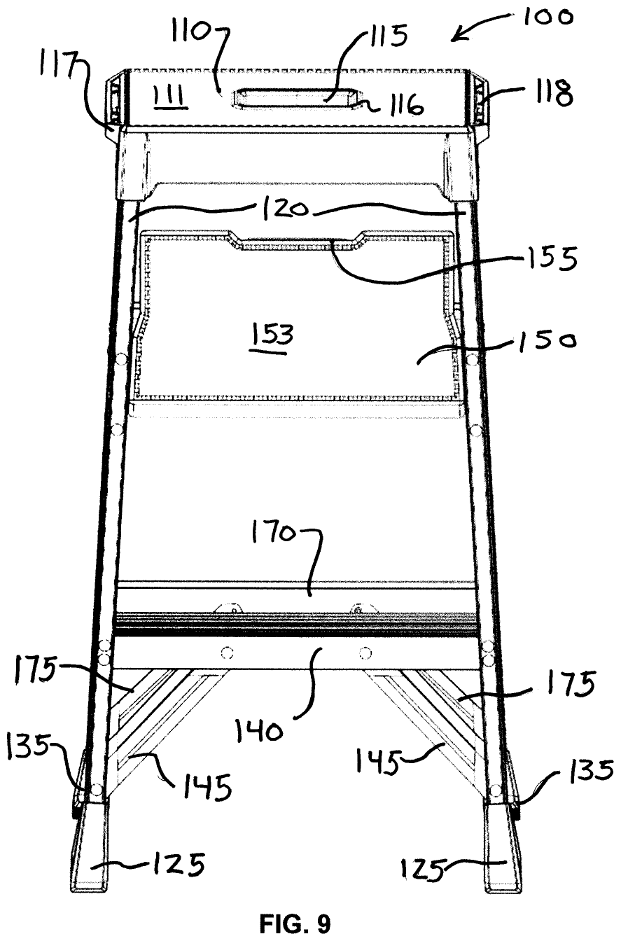

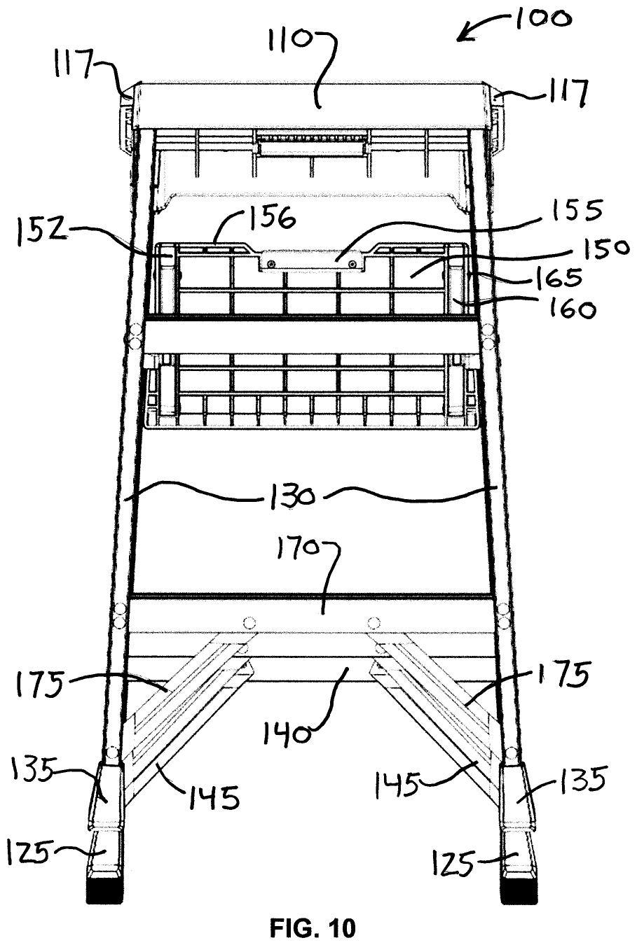

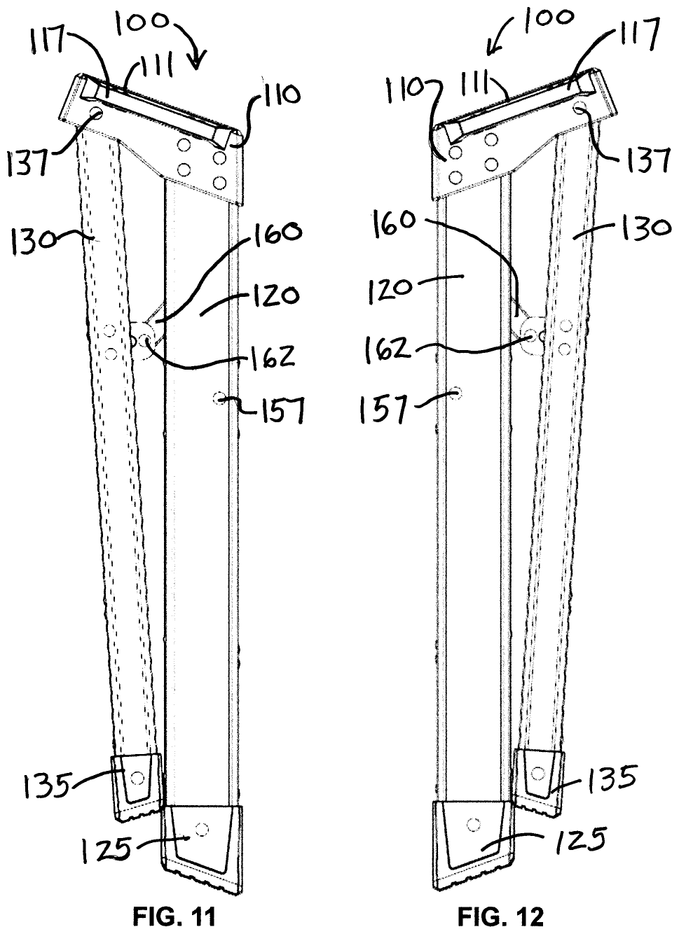

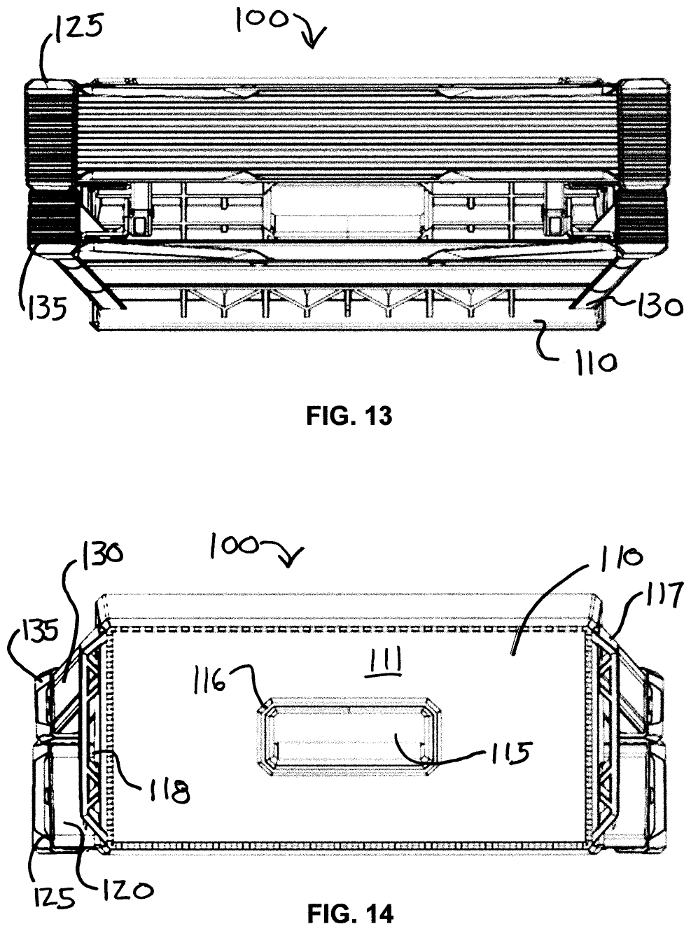

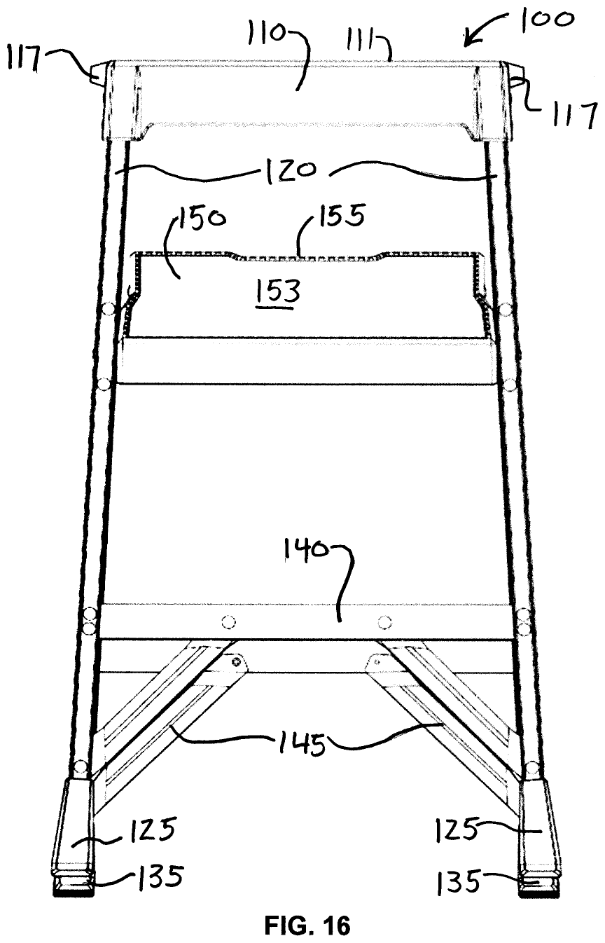

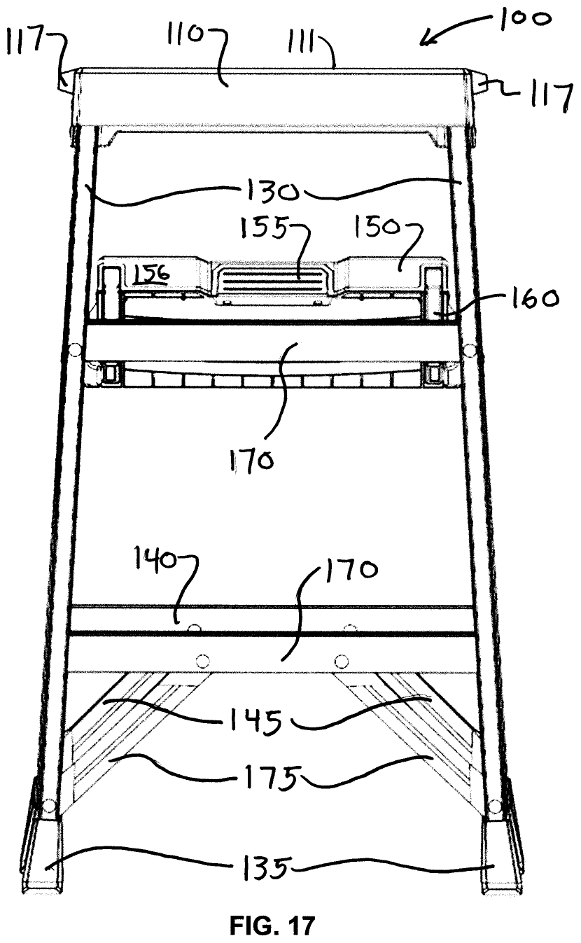

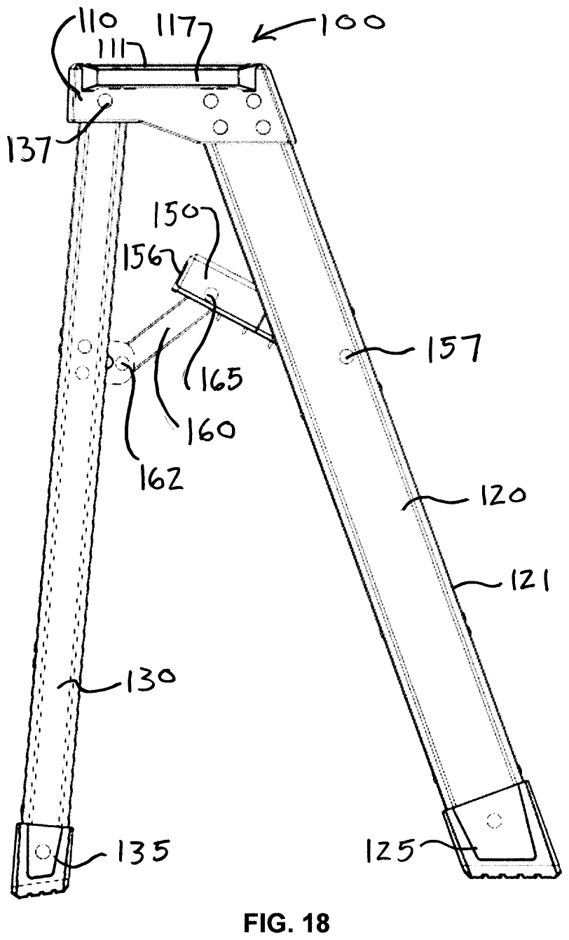

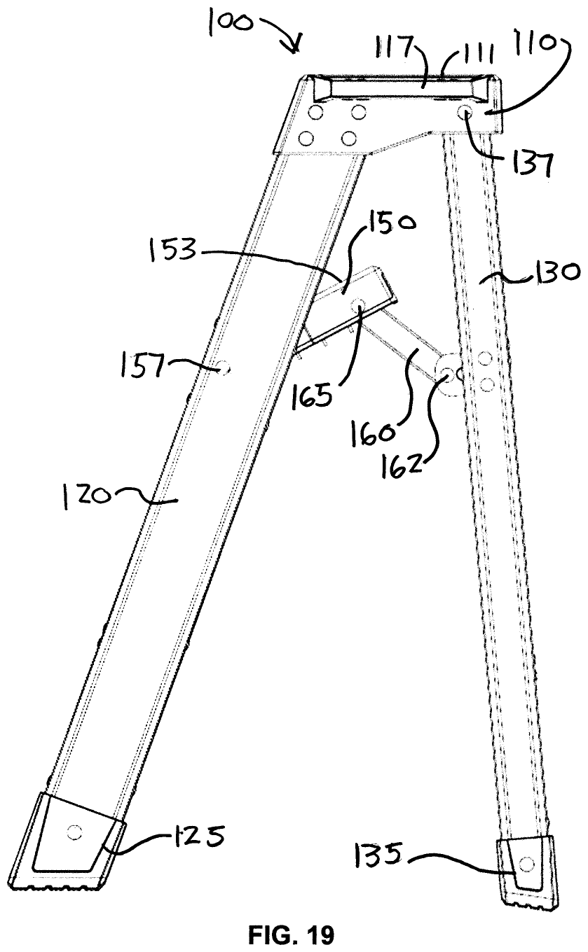

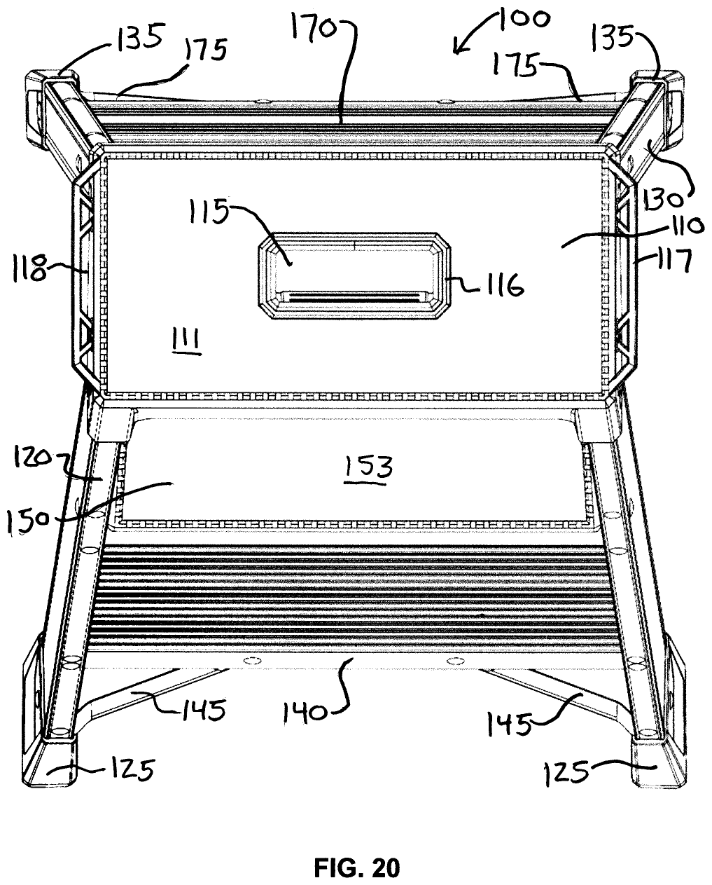

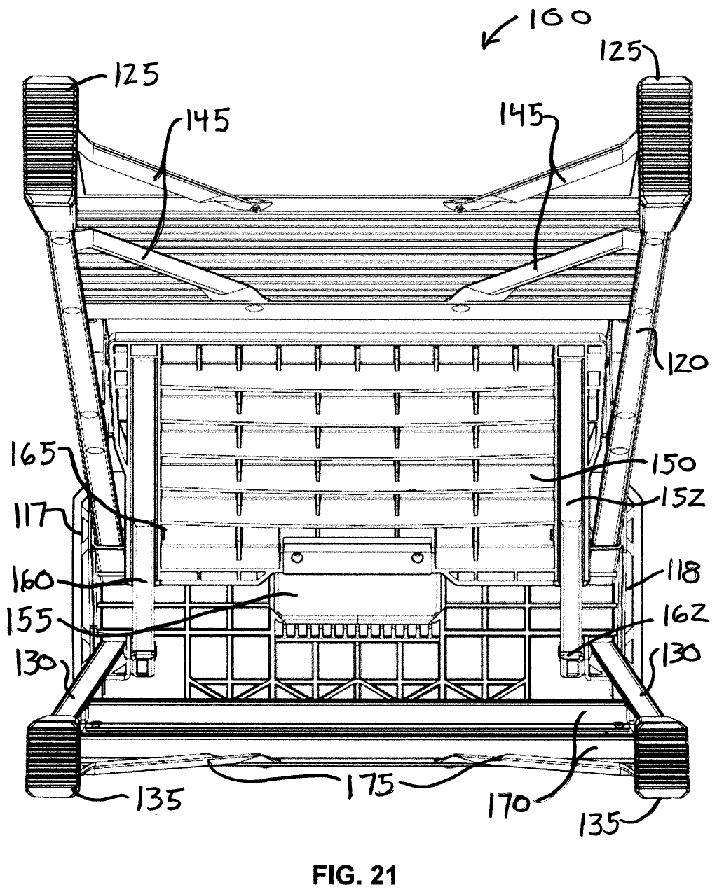

Referring now generally to FIGS. 1-21, a stepladder 100 is depicted, generally comprising a pair of front rails 120 having front faces 121 and pair of rear rails 130 connected to a top cap 110. The front rails 120 and rear rails 130 may be made of any suitable material known in the art, but are preferably aluminum channels to provide requsite strength and formability while being relatively light weight.

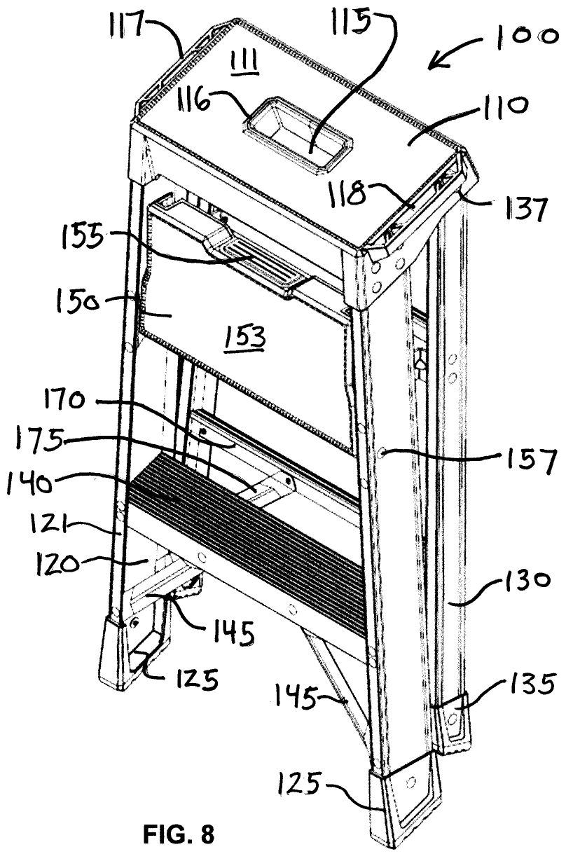

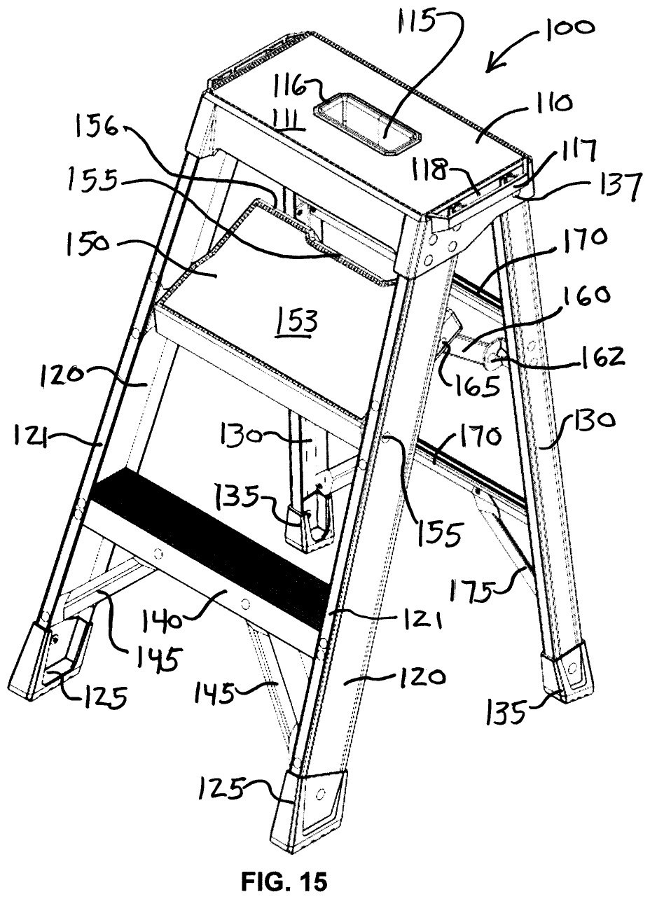

The top cap 110 may be made of any suitable material known in the art, but is preferably injection molding grade polypropylene. The top cap 110 has a top surface 111 and may also include a handle orifice 115 that allows a user you grasp the stepladder 100 is any orientation (FIG. 1—open, in-use position; FIG. 8—closed, store position; FIG. 15—intermediate position) for transport or placement of the stepladder 100. The handle orifice 115 is sized to fit four fingers of an average adult human hand. The top cap 110 may also include one or more tool bars 117 with one or more storage slots 118 for holding tools or hardware while using or transporting the stepladder 100. Preferably, the tool bars 117 are molded as part of the top cap 110, but may be separately formed and attached to the top cap 110. It is also preferable that the tool bars 117 are located on the sides of the top cap 110 so as to not interfere with climbing the stepladder 100. The top cap 110 may also include a handle grip 116 fitted within the handle orifice 115 to provide additional comfort when grasping the stepladder 100 for transport.

The preferred embodiment of the present invention has the top cap 110 fixedly attached to each of the front rails 120 and pivotably connected to the rear rails 130. Fixed connections for the stepladder 100 are preferably rivots for ease of manufacturing, satisfactory strength, and lower cost. Fixedly connected and spanning between the front rails 120 is at least one front step 140 for stepping upon, climbing, or standing when using the stepladder 100. To provide additional rigidity and strength, fronts step braces 145 may span between the front rails 120 and front step(s) 140. Front step 140 preferably has a width 141 substantially equal to the horizontal distance between the front and rear portions of the front rails 120 when the stepladder 100 is in the open position. This allows for the maximum space to place a foot while not extending beyond the profile of he front rails 120.

Also connected and spanning between the front rails 120 is a platform 150 pivotably connected to the each of the front rails 120 intermediate the top cap 110 and the at least one front step 140. Platform 150 has a top surface 153 and is preferably dimensioned to have a width 151 of at least twice the front step width 141 to provide a comfortable standing surface. Both front step(s) 140 and platform 150 preferably have textured top surfaces (ridged, knurled, etc.) to provide better traction while climbing or standing on those parts. This arrangement is an improvement over prior art stepladders in that it provides both a platform 150 for standing adjacent to the top cap 110, which also allows for standing, but without having any additional structure above the top cap 110 to interfere with using the stepladder 100. The platform 150 of the preferred embodiment is a unibody construction to provide strength, stiffness, lower cost of manufacturing, and less moving parts.

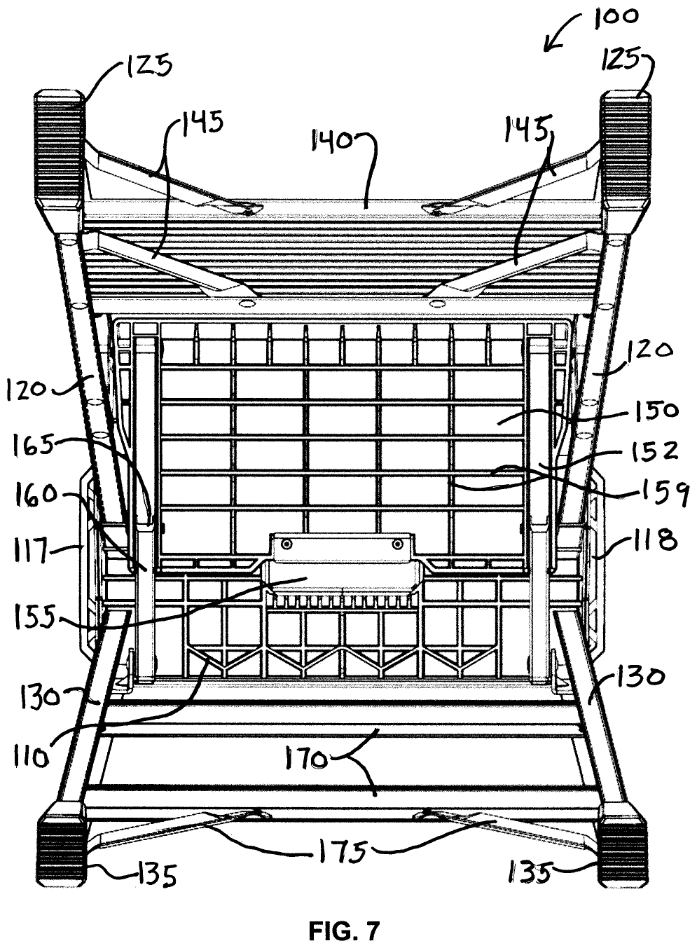

Platform 150 has a front face 154 and an interior wall 156 and preferably includes a handle 155 on the face between the front rails 120 and rear rails 130 for gripping to open and close the stepladder 100. The preferred embodiment of the platform 150 includes a platform channel 152 (see FIG. 7) that is formed by the platform ribs 159 and platform walls 158 that is preferably sized to accommodate a spreader arm 160 having a spreader arm longitudinal axis 161. The spreader arm 160 is pivotably connected to the platform 150 at a spreader pivot 165 at one end and pivotably connected to the rear rail 130 at the spreader arm 160 other end at a spreader arm pivot 162. Preferably there is a spreader arm 160 and platform channel 152 that span the left front rail 120 and left rear rail 130 and a a spreader arm 160 and platform channel 152 that span the right front rail 120 and right rear rail 130. Each set of platform channels 152 and spreader arms 160 forms and functions with their respective platform pivot 157, spreader arm pivot 162, and spreader pivot 165 as a spreader mechanism 168 for the stepladder.

When moving the stepladder from an open, in-use position (FIGS. 1-7) to a closed, stored position (FIGS. 8-15), a user may grasp the platform handle 155 and pull upward on the inside edge of the platform 150. This movement in combination with the spreader pivot 165 and spreader arm pivot 162 will result in the spreader arm 160 pulling its associate rear rail 130 toward its associated the front rail 120. FIGS. 15-22 illustrate the pivoting of the spreader mechanism 168 resulting in an intermediate position. Continuing this movement will result in the stepladder closing completely to the closed, stored position (FIGS. 8-14). Opening the stepladder 100 from a closed, store position to an open, in-use position may be accomplished by grasping the platform handle 155 and pushing it down or away from the front rails 120.

The platform channel 152 is configured to lock when the spreader arm 160 is parallel to the platform 150 by preventing the spreader arm 160 and platform 150 from pivoting beyond that position. This is accomplished by having the spreader pivot 165 located away from the platform wall 158 proximate the rear rail 130. This arrangement also provides protection against pinching fingers when opening or closing the stepladder 100.

The individual elements of the stepladder 100 may be constructed in whole or in part of wood, composites including glass fiber, carbon fiber or other known suitable composites, polymers, reinforced polymers including fiber-reinforced plastic (FRP), metal including aluminum or steel, or any combination thereof. The preferred embodiment uses aluminum for the front and rear rails 120, 130, crossbars 170, spreader arm 160, and rivots to provide the necessary strength with lower weight. The preferred embodiment uses injection molding grade polypropylene for the top cap 110, handle grip 116, platform 150, and front and rear feet 125, 135 to allow for more detailed formation, provide necessary strength, and surfaces that are slip resistant. The preferred material for the front step braces 145 and crossbar braces 175 is steel for strength.

The embodiments above are intended to be illustrative and not limiting. Additional embodiments are within the claims. In addition, although aspects of the present invention have been described with reference to particular embodiments, those skilled in the art will recognize that changes can be made in form and detail without departing from the scope of the invention, as defined by the claims. Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as will be understood by persons of ordinary skill in the art.

Any incorporation by reference of documents above is limited such that no subject matter is incorporated that is contrary to the explicit disclosure herein. Any incorporation by reference of documents above is further limited such that no claims that are included in the documents are incorporated by reference into the claims of the present Application. The claims of any of the documents are, however, incorporated as part of the disclosure herein, unless specifically excluded. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

1. A stepladder, comprising:
a top cap having a top surface;
a pair of front rails fixedly connected to the top cap, each front rail having a front face;
a pair of rear rails pivotably connected to the top cap;
a step fixedly coupled between the pair of front rails;
a spreader mechanism, comprising:
a platform pivotably coupled to the pair of front rails, the platform having a top surface and front face;
a spreader arm having a longitudinal axis pivotably coupled to the pair of rear rails; and
a spreader pivot; and
wherein the stepladder is configured to be movable between a closed position and an open position.

2. The stepladder of claim 1, wherein the open position of the stepladder is limited by the spreader mechanism.

3. The stepladder of claim 2, wherein the spreader arm is a single unibody structure.

4. The stepladder of claim 1, wherein the spreader arm longitudinal axis and platform top surface are oriented generally parallel to the top cap top surface when the stepladder is in the open position.

5. The stepladder of claim 4, wherein the spreader arm longitudinal axis, platform top surface, and top cap top surface are oriented generally parallel to a surface upon which the stepladder is located when the stepladder is in the open position.

6. The stepladder of claim 1, wherein the platform comprises an interior wall and the spreader pivot is distal to the interior wall.

7. The stepladder of claim 6 further comprising a platform handle attached to the platform interior wall.

8. The stepladder of claim 1 wherein the platform is a single unibody structure.

9. The stepladder of claim 8 wherein the platform front face is adjacent the front rail front faces.

10. The stepladder of claim 1, wherein the platform top surface is generally coplanar to the front rail front face when the stepladder is in the closed position.

11. The stepladder of claim 1, wherein the platform comprises a channel and the platform channel accommodates a portion of the spreader arm.

12. A stepladder, comprising:
a top cap having a top surface;
a pair of front rails fixedly connected to the top cap, each front rail having a front face;
a pair of rear rails pivotably connected to the top cap;
a step fixedly coupled between the pair of front rails;
a spreader mechanism, comprising:
a platform pivotably coupled to the pair of front rails, the platform having a top surface and front face;
a spreader arm having a longitudinal axis pivotably coupled to the pair of rear rails; and
a spreader pivot; and
wherein the stepladder is configured to be movable between a closed position wherein the front rail front faces are coplanar with the platform top surface and an open position wherein the spreader arm longitudinal axis and platform top surface are oriented generally parallel to the top cap top surface.

13. The stepladder of claim 12 wherein the platform is a single unibody structure.

14. The stepladder of claim 12, further comprising a crossbar fixedly coupled between the pair of rear rails.

15. The stepladder of claim 12, wherein the open position of the stepladder is limited by the spreader mechanism.

16. The stepladder of claim 1, wherein the platform comprises a channel and the platform channel accommodates a portion of the spreader arm.

17. A stepladder, comprising:
a top cap;
a pair of front rails fixedly connected to the top cap;
a pair of rear rails pivotably connected to the top cap;
a step fixedly coupled between the pair of front rails;
a spreader mechanism, comprising:
a platform pivotably coupled to the pair of front rails, the platform having a channel;
a spreader arm pivotably coupled to the pair of rear rails; and
a spreader pivot; and
wherein the stepladder is configured to be movable between a closed position and an open position and wherein the platform channel accommodates at least part of the spreader arm.

18. The stepladder of claim 17 wherein the platform is a single unibody structure.

19. The stepladder of claim 18, wherein the spreader arm is a single unibody structure.

20. The stepladder of claim 17 wherein the platform comprises an interior wall and the spreader pivot is distal to the interior wall.
